(19) United States
(12) Patent Application Publication
(10) Pub. No.: US 2016/0037795 A1
(43) Pub. Date: Feb. 11, 2016

(54) METHOD OF MAKING A HEAT STABLE CHOCOLATE CONFECTIONERY PRODUCT

(71) Applicant: THE HERSHEY COMPANY, Hershey, PA (US)

(72) Inventors: Xiaoying WANG, Hummelstown, PA (US); Brian BAKER, Millersburg, PA (US); David WORTHING, Middletown, PA (US); Maria J. PEREZ GONZALEZ, Hummelstown, PA (US); Gagan MONGIA, Hershey, PA (US)

(21) Appl. No.: 14/774,825

(22) PCT Filed: Mar. 14, 2014
(86) PCT No.: PCT/US2014/027398

§ 371 Date: Sep. 11, 2015

Related U.S. Application Data
(60) Provisional application No. 61/788,306, filed on Mar. 15, 2013.

(51) Int. Cl. A23G 1/36; A23G 1/46; A23G 1/40

(52) U.S. Cl. CPC A23G 1/36; A23G 1/40; A23G 1/46; A23V 2002/00

(57) ABSTRACT

A method for creating a heat resistant confectionery product is disclosed that includes incorporating one or more finely milled ingredients to a mixture containing a chocolate compatible fat. The method includes providing the mixture containing the chocolate compatible fat, incorporating a powder of one or more dry ingredients used in the confectionery product, the powder having a particle size in the range of 5 to 55 microns, agitating the mixture and the pulverized powder to form a uniform cohesive dough and thereafter solidifying the dough to form the confectionery product.

### CROSS-REFERENCE TO RELATED APPLICATIONS

This application claims priority to and the benefit of U.S. Provisional Application No. 61/788,306 filed Mar. 15, 2013, which is hereby incorporated by reference in its entirety.

### FIELD

This application is directed to the manufacture of confectionery products and more particularly to the manufacture of heat stable chocolate and chocolaty candy.

### BACKGROUND

Traditional chocolate making methods are well known and involve several basic steps carried out in a particular order. Generally, the process starts with cocoa beans harvested from pods of melon-like fruit that grow on the cacao tree. The cocoa beans are removed from the pods and placed in large heaps or piles to ferment, during which the shells of the beans harden and darken and a rich cocoa flavor develops.

Dried cocoa beans are roasted at very high temperatures and hulled to separate the shell from the inside of the bean, also called a “nib,” the part of the bean actually used to make chocolate. The nibs are milled by a grinding process that turns the nibs into a liquid called chocolate liquor.

The chocolate liquor, which is sometimes separated in advance into its constituents, cocoa butter and cocoa powder, is mixed with a sweetener, usually sugar, and in the case of milk chocolate, milk solids are also added.

The chocolate liquor is also combined with milk and sugar and is dried to a coarse, brown powder called chocolate crumb. Additional cocoa butter may be added to the chocolate crumb, after which the mixture passes through steel rollers which refine the mixture above the melting point of the cocoa butter, resulting in a chocolate powder. The chocolate powder is then conched, a process in which the chocolate powder is maintained above the fat melting temperature while mixing elements smooth out gritty particles, remove moisture and off-flavors, and develop pleasant flavors. Conching also releases fat from the chocolate powder, increasing the fat coating on the particles so that the chocolate has a proper fluidity for further processing. Additional fat is added to achieve the full formulated fat content and emulsifiers are also added to reduce viscosity and enhance fluidity of the chocolate paste. The liquid chocolate paste is tempered and then poured or deposited into a mould to produce a chocolate bar or used for enrobed products.

The melting temperature of cocoa butter and other fats sometimes used with or in place of cocoa butter in certain chocolate making processes is in the range of 29° C. to 35° C. As a result, chocolate bars and other chocolate confections cannot always be readily transported, stored or enjoyed in the summertime or in tropical climates where temperatures of unconditioned spaces typically reach or exceed the melting point of the fat in the chocolate. Even where the confections are stored or consumed in a conditioned space, if they melt during transit and then resolidify, the products may become misshapen or exhibit bloom, a condition in which the melted fat in the chocolate recrystallizes in a different structure resulting in a change in appearance or texture that can render the product unappealing.

Various attempts have been directed to trying to develop a heat stable chocolate that could better withstand conditions of elevated temperature. Efforts to date have generally involved modifying formulations by adding ingredients to the chocolate that provide heat stability. In some cases, special ingredients are added that are designed to absorb moisture during processing or after packaging. In other cases, water is incorporated directly into the chocolate during manufacture, such as using water-oil emulsions. However, chocolate products made using these kinds of additional ingredients generally have a dry, crumbly texture that is undesirable and also suffer from flavor deterioration over a shorter shelf life as a result of the high moisture content. In still other cases, high melting fats have been used, but chocolate confections having these kinds of fats are also disfavored because they tend to have a negative, waxy eating quality.

These and other drawbacks are associated with current methods of confectionery production.

One recently proposed method by Wang et al (WO 2012/129080) employs substantially traditional chocolate formulas using traditional chocolate making ingredients with a unique process in which ingredients are mixed and refined in a manner that forms a cohesive dough. The dough is formed into pieces as a final chocolate product that can keep its shape and be handled above the melting point of the employed fat.

While this process is useful, additional improvements to this dough manufacturing method for the formation of chocolate products that withstand exposure to elevated temperatures are desirable.

### SUMMARY

Exemplary embodiments are directed to methods of making heat resistant chocolate confections using traditional chocolate making ingredients in which a portion of the dry ingredients are withheld from initial production steps. The withheld ingredients are pulverized/milled to a fine particle size and then added to a liquid stream formed in the initial steps to achieve a dough.

In one embodiment, a method for creating a heat resistant confectionery product includes providing a mixture containing a chocolate compatible fat, incorporating a powder of one or more dry ingredients used in the confectionery product, the powder having a particle size in the range of 5 to 55 microns, agitating the mixture and the pulverized powder to form a uniform cohesive dough and thereafter solidifying the dough to form the confectionery product.

In many embodiments, the powder includes sweetener, such as sugar. In some embodiments, the powder includes at least 50% by weight of the amount of sugar or other sweetener used in forming the confectionery product.

In another embodiment, a method for creating a confectionery product comprises providing a mixture comprising sugar, cocoa butter and cocoa powder, refining and conching the mixture comprising sugar, cocoa butter and cocoa powder to form a flowable liquid, thereafter incorporating into the liquid a fine powder comprising sugar, the fine powder having a particle size less than 45 microns, wherein the fine powder is incorporated as at least 20% by weight of the confectionery product, agitating the liquid and fine powder at a temperature above the melting temperature of the cocoa butter to form a cohesive dough, and thereafter solidifying the dough to form the confectionery product having a fat content in the range of 28% to 33% by weight.

An advantage of exemplary embodiments is that dry ingredients can be finely milled and added just prior to or during dough formation.

An advantage is that chocolate confectionery products produced in accordance with exemplary embodiments have a rheology such that the product maintains its shape above the melting temperature of the fat in the chocolate, without becoming messy or liquid-like.

Another advantage is that chocolate confectionery products produced in accordance with exemplary embodiments can be formulated with the same overall fat content as chocolate confectioneries produced by traditional methods.

Yet another advantage is that methods in accordance with exemplary embodiments can produce chocolate confections using traditional chocolate making ingredients and avoid the kind of additives previously used to create heat stable chocolate that result in undesirable eating qualities and poor shelf life.

Other features and advantages of the present invention will be apparent from the following more detailed description of exemplary embodiments that illustrate, by way of example, the principles of the invention.

### DETAILED DESCRIPTION OF EXEMPLARY EMBODIMENTS

Exemplary embodiments are directed to producing chocolate confectionery products that do not need to be specially formulated and can be made with traditional chocolate making ingredients, but which still exhibit heat stable characteristics. Methods in accordance with exemplary embodiments result in a chocolate confectionery product having a rheology such that the product retains its shape above the melting point of fats in the product, while retaining a flavor and mouthfeel comparable with chocolate made by traditional methods.

Exemplary embodiments include sequential steps of providing a blended mixture followed by refining and agitating/kneading to obtain a chocolate dough that can be shaped and solidified to form the confectionery product. At least some of the ingredients, and in particular a portion of the sweetener, is withheld from the initial blended mixture, milled to a fine particle size, and then added during the step of dough formation. In other embodiments, an initial dry mixture is pulverized and added to the fat during the step of dough formation.

It will be appreciated that the term “chocolate” may have a legal definition in certain countries relative to particular amounts of cocoa solids, cocoa butter or other ingredients, such as milk fat and/or milk powder, and that the definition may vary from country to country. As used herein, however, the term “chocolate confection” or “chocolate confectionery product” is meant to encompass the broad category of any confectionery product that includes a chocolate compatible fat, including traditional chocolate containing cocoa solids and cocoa butter, as well as those products sometimes referred to as chocolaty candy or chocolate compound that make use of additional fats and/or chocolate flavorings in place of cocoa solids and/or cocoa butter, along with the category of candy known as white chocolate.

According to exemplary embodiments, a batch is prepared that includes a chocolate compatible fat and that typically further includes cocoa solids, but which may be eliminated, for example, in methods for producing white chocolate. The cocoa solids may be introduced, for example, as cocoa powder and/or as chocolate liquor in which the cocoa solids are not yet separated from the cocoa butter.

A sweetener may also be included in the batch, but if so, less than about 40% of the total amount of sweetener to be employed is typically included, with the balance being added as a finely milled powder during dough formation as described subsequently in more detail. A dry sweetener is typically used and the sweetener is preferably, but not necessarily, sugar. Other sweeteners may include polyols, corn syrup solids, and fructo-oligosaccharide/inulin, by way of example only, although liquid sweeteners are generally excluded.

The chocolate compatible fat is preferably cocoa butter, but may also be any of the vegetable or other fats known in the chocolate industry for use in combination with or in place of cocoa butter. Such fats are typically classified as one of the following categories: cocoa butter equivalents (e.g., fractionated palm oil, illipe and shea nut butter), cocoa butter replacements (e.g., fractionated and partially hydrogenated soybean, cottonseed and palm oils) and cocoa butter substitutes (e.g., fractionated and partially hydrogenated lauric fat compounds). The chocolate compatible fat may be any of the foregoing categories of fats or may be a combination of one or more types of fats from different categories.

As already noted, in some embodiments, chocolate liquor may be used to introduce both cocoa solids and cocoa butter; in that case, additional chocolate compatible fat may be blended into the mixture to achieve the desired total fat content. When chocolate confections are made using chocolate liquor as part of the formulation, the chocolate liquor may contain high levels of unpleasant notes and the mixture may be subjected to a pre-refining or post-refining conch process. The conch process involves mixing the blended mixture at elevated temperatures (above the fat melting temperature) for several or more hours, e.g. at 50° C. for 3 hours, to remove off notes and develop pleasant flavors.

For embodiments such as white chocolate and milk chocolate confections, milk (preferably dairy milk) may be blended into the mixture. The milk may be provided as powdered milk; alternatively, liquid milk may also be used but which may introduce an intermediate drying step to remove excess moisture prior to refining. Furthermore, the powdered milk may contain fat (i.e. whole milk powder) or may be nonfat (non fat dry milk).

It will further be appreciated that in some embodiments, such as in the manufacture of dark chocolate confections, it may be desirable to provide milk fat but not milk solids. In some embodiments, additives such as soy protein, rice flour, whey, and the like may be added in addition to or in place of milk solids.

In certain embodiments, such as white chocolate, the initial batch contains only cocoa butter and milk fat. In other embodiments, the initial batch contains only cocoa liquor that is pre-milled (such as using a ball mixer) to a predetermined particle size.

It will further be appreciated that flavorants, such as natural vanilla, vanillin or other extracts, as well as preservatives, such as tocopherols, and other minor ingredients, such as emulsifiers, used in traditional chocolate formulations may also be blended into the mixture.

The initial batch ingredients according to a particular confection formulation are typically blended and refined. The refining results in decreased particle size of the mixture, generally in the range of about 5 to about 50 microns, typically about 10 to about 40 microns, and preferably in the range of about 20 to about 30 microns. The reduction of particle size increases the surface area of the non-fat ingredients. More free fats are trapped to the newly formed surface, resulting in a dry chocolate powder from the liquid blend introduced to the refiner. The post-refined material is then typically conched at elevated temperature for one or more hours, producing a liquid that has the texture of a traditional flowable chocolate paste.

After conching, the blend may optionally be standardized, for example, through the introduction of additional cocoa butter or fat, prior to or with the introduction of the pulverized components.

To this liquid paste stream, the balance of the chocolate confectionery formulation, typically including the majority of the sweetener, is added in the form of a finely milled powder, typically in the range of 5 to 55 microns in particle size, more typically not greater than 40-45 microns and preferably not greater than 25 microns. While referred to as a stream, it will be appreciated that this does not require a continuous process.

The fine milled powder can be obtained using a jet pulverizer or other suitable dry milling methods. The dry ingredients used to form the finely milled powder added to the post-refined stream can be any dry ingredients used in the chocolate formulation, including sugar, cocoa powder, non-fat dairy milk powder, whole milk powder, lactose, corn syrup solids, dextrose, soluble fibers, whey, or any combination thereof. Thus, while the bulk of the fine milled powder is typically sugar (preferably sucrose), other ingredients may also be employed to achieve the total overall product formulation in the resulting confectionery product.

The relative amount of the fine milled powder may vary depending upon which ingredients are withheld for introduction into the paste as fine powder to form dough. For a chocolate confectionery having a fat content in a range of 28% to 33% by weight, the fine milled powder is added to the post-refined stream as at least 5% by weight of the resulting confectionery product. The powder is added as 7% to 10% by weight if fine milled cocoa powder is added. In the more typical case in which the fine milled powder includes sugar, the powder is added as at least 20% by weight more typically the fine milled powder contains the majority of the formulated sugar content is added in the range of 30% to 50% by weight and preferably in the range of 40% to 45% by weight of the total resulting confectionery product. However, in some embodiments, the fine milled powder may be added in a range of to 55% to 72% by weight of the confectionery product.

During the addition of the powder, the mixture is subjected to gentle agitation via a slow kneading process carried out at or above the melting temperature of the chocolate compatible fat, typically in the range of 29° C. to 31° C., to obtain a dough. The kneading stops when the post-refined material forms a non-flowable chocolate dough, which may take as few as two to five minutes and typically from five to ten minutes, although up to twenty minutes or more may be needed depending on the fat content.

In embodiments in which kneading lasts more than about five minutes, a small amount of emulsifier can be added to facilitate dough formation. Generally, emulsifiers are avoided as they reduce dough firmness, which affects heat resistance of the final chocolate product. The particular amount of emulsifiers, if any, may vary depending on several factors including the total fat content, the total weight of the formula added as fine milled powder, and the specific components added as fine milled powder. Thus, some embodiments employ no emulsifiers, while 0.1-0.5% by weight of lecithin and/or polyglycerol polyricinoleate (PGPR) can be employed. In certain cases, as much as 1% by weight of an emulsifier may be used.

Nuts, coconut, and other types of inclusions commonly incorporated into chocolate confections can be added during kneading to incorporate these additional ingredients into the end product.

To make a tempered chocolate dough, a portion of total formulated fat, typically in the range of 0.5-1% by weight, may be omitted from the initial formulation for later addition. Instead, that remaining fat can be added as tempering seeds near the conclusion of the kneading process as the dough forms, as the mixing continues until the dough is obtained. The tempering seeds can be tempered cocoa butter in dry powder form or tempered cocoa butter in dispersed paste form. A tempered chocolate paste can also be used as seeds to obtain a tempered chocolate dough.

In some embodiments, a tempered chocolate dough can also be obtained by tempering the refined stream first, followed by adding the fine milled powder with agitation to form the dough, while controlling the dough temperature below the chocolate seed melting temperature, e.g. 29° C. to 31° C.

The resultant chocolate dough can then be shaped and solidified to form the chocolate confectionery product. Because the chocolate dough is not flowable, it is formed into its shape for ultimate consumption other than by the liquid depositing or enrobing used in traditional chocolate making. The chocolate dough can be formed into pieces of any desired shape by any suitable shaping methods such as rotary molding, sheeting, extrusion, depositing, drop rolling, stamping, frozen cone, or panning all by way of example.

In one embodiment, a rotary moulding machine may be used to shape and form the chocolate confectionery product. The moulding machine includes a water jacketed roll to which a die of a desired shape is mounted. The roll temperature may be controlled within the chocolate dough working range, typically 27° C. to 33° C. for tempered chocolate and more preferably 29.5° C. to 31° C. For embodiments in which a non-tempering chocolate compatible fat is employed, the dough working range may be any suitable temperature at or above the fat melting temperature and the roll temperature may be controlled accordingly.

After forming into the desired piece shape, the chocolate confection may then be cooled in a cooling tunnel or other conventional technique for piece solidification. In some embodiments, it may be desirable to apply a confectionery glaze or shellac over the pieces after shaping, either prior to or after solidification.

Chocolate confectionery products made in accordance with exemplary embodiments of the invention employ chocolate dough having a firm, viscoelastic-like rheology formed above the melting temperature of the chocolate compatible fat used to create the confection. As a result, that is the rheology to which the chocolate confection reverts if the confection is subsequently heated back above the fat melting temperature, as might be the case in hot weather and/or tropical climates.

While the distinction between a dough formed according to the processes described in accordance with exemplary embodiments and a flowable paste or liquid formed in accordance with traditional chocolate making methods will be readily apparent to those of ordinary skill in the art, the dough may further be characterized as exhibiting a minimum resistance force of 1.5×10⁴ Pa under a compression deformation of 2.5 mm at 0.2 mm/sec penetration speed using a 0.25 inch diameter plastic cylindrical probe at 45° C., or a minimum peak force of 50 grams using TA-XT2 Analyser under those conditions. Conversely, a traditional chocolate has a peak force less than 10 g under those circumstances.

Chocolate confections made in accordance with exemplary embodiments exhibit good heat stability and under such conditions are capable of retaining their shape and can be picked up without leaving a significant chocolaty residue on surfaces they touch, as is associated with the mess left when chocolate melts that is made by traditional methods. Furthermore, chocolate confections made in accordance with exemplary embodiments have a shelf life of at least six months, even at temperatures of 32.2° C. or above. In addition to advantages associated with heat stability, unlike known heat resistant chocolate products, chocolate confections made in accordance with exemplary embodiments have a smooth, non-grainy texture, with a mouthfeel and taste comparable to chocolate made by traditional methods which do not have heat resistant qualities.

### EXAMPLES

The invention is further described in the context of the following examples, which are presented by way of illustration, not of limitation.

### Example 1

The ingredients shown in Table 1-1 were mixed in a batch and refined to 22 microns.

TABLE 1-1

| Ingredient | Weight % |
|---|---|
| Sugar (sucrose) | 21.0 |
| Non-fat dry milk | 35.81 |
| Cocoa liquor | 35.8 |
| Cocoa butter | 7.39 |

Thereafter, the refined material was conched for one hour at 50° C. To this was added cocoa butter and anhydrous milk fat to yield a chocolate stream as shown in Table 1-2.

TABLE 1-2

| Ingredient | Weight % |
|---|---|
| Refined material (Table 1-1) | 67.04 |
| Cocoa butter | 26.80 |
| Anydrous milk fat | 6.16 |

A chocolate dough was formed by mixing sugar containing 3% by weight cocoa powder that had been pulverized in a jet mill to an average particle size of 17 microns as shown in Table 1-3.

TABLE 1-3

| Ingredient | Weight % |
|---|---|
| Chocolate Stream (Table 1-2) | 55.14 |
| Pulverized powder | 43.86 |
| (sugar with 3% wt cocoa) | |
| Cocoa butter seed | 1.0 |

The mixture was gently agitated while the temperature was maintained at 29.4° C. to 30° C. using water bath cooling. The tempered cocoa butter seed powder shown in Table 1-3 was added at the time the dough was about to form. The dough was then kneaded for another one to two minutes until the cocoa butter seeds were distributed uniformly.

The tempered chocolate dough was moulded into small bars having an approximate size of 1 inch by 1.75 inches by 0.25 inches. The final chocolate had 29.3% by weight fat. Heat resistance testing was carried out using a TA-XT2 Texture Analyzer. The produced pieces had an average texture reading of 441 g peak force at 35° C. and 414 g at 50° C., demonstrating their heat resistance.

### Example 2

The ingredients shown in Table 2-1 were mixed in a batch and refined to 21 microns.

TABLE 2-1

| Ingredient | Weight % |
|---|---|
| Sugar (sucrose) | 21.51 |
| Cocoa liquor | 71.68 |
| Cocoa powder | 6.8 |
| Vanillin | 0.01 |

Thereafter, the refined material was conched for one hour at 50° C. A chocolate dough was formed by directly mixing sugar containing 3% by weight cocoa powder that had been pulverized in a jet mill to an average particle size of 17 microns into the post-refined stream, along with additional cocoa butter and anhydrous milk fat as shown in Table 2-2.

TABLE 2-2

| Ingredient | Weight % |
|---|---|
| Chocolate Stream (Table 2-1) | 50.22 |
| Pulverized powder | 40.0 |
| (sugar with 3% wt cocoa) | |
| Cocoa butter | 6.78 |
| Anydrous milk fat | 2.0 |
| Cocoa butter seed | 1.0 |

The mixture was gently agitated while the temperature was maintained at 29.4° C. to 30° C. using water bath cooling. The tempered cocoa butter seed powder shown in Table 2-2 was added at the time the dough was about to form. The dough was then kneaded for another one to two minutes until the cocoa butter seeds were distributed uniformly.

The tempered chocolate dough was moulded into small bars having an approximate size of 1 inch by 1.75 inches by 0.25 inches. The final chocolate had 30.0% by weight fat. Heat resistance testing was carried out using a TA-XT2 Texture Analyzer. The produced pieces had an average texture reading of 258 g peak force at 35° C. and 294 g at 50° C., demonstrating their heat resistance.

### Example 3

Cocoa liquor was ball milled to an average particle size of 13 microns. Thereafter, the ingredients shown in Table 3 were added to the ball milled liquor, except for the cocoa butter seeds and pulverized powder.

TABLE 3

| Ingredient | Weight % |
|---|---|
| Ball milled liquor | 30.68 |
| Cocoa butter | 10 |
| Anhydrous milk fat | 3.3 |
| Vanillin | 0.02 |
| Pulverized powder | 55.0 |
| (dextrose monohydrate with 5% wt cocoa) | |
| Cocoa butter seed | 1.0 |

The first four ingredients were mixed and cooled to about 32.2° C. At that point, a pulverized powder of dextrose monohydrate containing 5% by weight cocoa powder was added which had been jet milled to an average particle size of 30 micron. The mixture was gently agitated while the temperature was maintained at 29.4° C. to 30° C. using water bath cooling. The tempered cocoa butter seed powder was added at the time the dough was about to form. The dough was then kneaded for another one to two minutes until the cocoa butter seeds were distributed uniformly.

The tempered chocolate dough was moulded into small bars having an approximate size of 1 inch by 1.75 inches by 0.25 inches. The final chocolate was 31.4% by weight fat. Heat resistance testing was carried out using a TA-XT2 Texture Analyzer. The produced pieces had an average texture reading of 217 g peak force at 35° C. and 655 g at 50° C., demonstrating their heat resistance. The additional gain in heat resistance with this example is believed to be at least partially attributable to the release of water by the dextrose monohydrate at the higher temperature.

### Example 4

The ingredients shown in Table 4-1 were mixed in a batch and refined to 21 microns.

TABLE 4-1

| Ingredient | Weight % |
|---|---|
| Sugar (sucrose) | 18.75 |
| Non-fat dry milk | 31.25 |
| Cocoa butter | 18.75 |
| Whole milk powder | 20.0 |
| Lactose | 6.25 |
| Anhydrous milk fat | 5.0 |

Thereafter, the refined material was conched for one hour at 50° C. To this was added cocoa butter to yield a stream as shown in Table 4-2.

TABLE 4-2

| Ingredient | Weight % |
|---|---|
| Refined material (Table 4-1) | 80.0 |
| Cocoa butter | 20.0 |

A white chocolate dough was formed by mixing sugar containing 3% by weight corn starch that had been pulverized in a jet mill to an average particle size of 17 microns into the stream along with additional cocoa butter and some vanillin as shown in Table 4-3.

TABLE 4-3

| Ingredient | Weight % |
|---|---|
| Chocolate Stream (Table 4-2) | 55.14 |
| Cocoa butter | 4.2 |
| Vanillin | 0.02 |
| Pulverized powder | 37.0 |
| (sugar with 3% wt corn starch) | |
| Cocoa butter seed | 1.0 |

The mixture was gently agitated while the temperature was maintained at 29.4° C. to 30° C. using water bath cooling. The tempered cocoa butter seed powder shown in Table 4-3 was added at the time the dough was about to form. The dough was then kneaded for another one to two minutes until the cocoa butter seeds were distributed uniformly.

The tempered chocolate dough was moulded into small bars having an approximate size of 1 inch by 1.75 inches by 0.25 inches. The final chocolate had 30.3% by weight fat. Heat resistance testing was carried out using a TA-XT2 Texture Analyzer. The produced pieces had an average texture reading of 274 g peak force at 35° C. and 386 g at 50° C., demonstrating their heat resistance.

### Example 5

The ingredients shown in Table 5-1 were mixed in a batch and blended. This dry mixture was then pulverized in a jet mill to form a blend having an average particle size of about 21 to 22 microns.

TABLE 5-1

| Ingredient | Weight % |
|---|---|
| Sugar | 55.1 |
| Non-fat dry milk | 23.9 |
| Whole milk powder | 14.2 |
| Lactose | 6.8 |

A chocolate dough was formed by combining cocoa butter, anhydrous milk fat, vanillin and cocoa butter seed powder to the pulverized powder in the amounts shown in Table 5-2, while the temperature was maintained at 29.4° C. to 30° C. using water bath cooling. The tempered cocoa butter seed was added at the time the dough was about to form. The dough was then kneaded for another one to two minutes until the cocoa butter seeds were distributed uniformly.

TABLE 5-2

| Ingredient | Weight % |
|---|---|
| Pulverized Powder (Table 5-1) | 70.58 |
| Cocoa butter | 24.3 |
| Vanillin | 0.02 |
| Anhydrous milk fat | 4.1 |
| Cocoa butter seed | 1.0 |

The tempered chocolate dough was moulded into small bars having an approximate size of 1 inch by 1.75 inches by 0.25 inches. The final chocolate had 30.5% by weight fat. Heat resistance testing was carried out using a TA-XT2 Texture Analyzer. The produced pieces had an average texture reading of 514 g peak force at 35° C. and 523 g at 50° C., demonstrating their heat resistance.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for creating a confectionery product comprising:
providing a mixture comprising a chocolate compatible fat;
incorporating a powder comprising a dry ingredient of the confectionery product having a particle size in the range of 5 to 55 microns;
agitating the mixture and the pulverized powder to form a uniform cohesive dough; and thereafter
solidifying the dough to form the confectionery product.

2. The method of claim 1, wherein the powder comprises a dry ingredient of the confectionery product having a particle size in the range of 5 to 55 microns includes a sweetener.

3. The method of claim 2, wherein the sweetener is sugar.

4. The method of claim 3, wherein a majority of the sugar in the confectionery product is introduced via the powder having the particle size in the range of 5 to 55 microns.

5. The method of claim 2, wherein the powder comprises a dry ingredient selected from the group consisting of cocoa powder, non-fat dairy milk powder, whole milk powder, lactose, corn syrup solids, dextrose, soluble fibers, whey, or combinations thereof.

6. The method of claim 1, wherein the powder particle size is less than 45 microns.

7. The method of claim 1, wherein the powder particle size is less than 25 microns.

8. The method of claim 1, wherein the chocolate compatible fat is cocoa butter.

9. The method of claim 1, wherein the chocolate compatible fat is selected from the group consisting of fractionated palm oil, illipe butter, shea nut butter, fractionated and partially hydrogenated soybean oil, fractionated and partially hydrogenated cottonseed oil, fractionated and partially hydrogenated palm oil, fractionated and partially hydrogenated lauric fat compounds, and combinations thereof.

10. The method of claim 1, further comprising conching the mixture prior to the step of incorporating the powder.

11. The method of claim 1, wherein the powder having a particle size in the range of 5 to 55 microns is fat free.

12. The method of claim 1, wherein the powder is incorporated as at least 5% by weight of the formed confectionery product.

13. The method of claim 1, wherein the powder is incorporated as at least 20% by weight of the formed confectionery product.

14. The method of claim 1, wherein the powder is incorporated as at least 35% by weight of the formed confectionery product.

15. The method of claim 1, wherein the formed confectionery product has a fat content in the range of 28% to 33% by weight of the formed confectionery product.

16. A method for creating a confectionery product comprising:
providing a mixture comprising sugar, cocoa butter and cocoa powder;
refining and conching the mixture comprising sugar, cocoa butter and cocoa powder to form a flowable liquid; thereafter
incorporating into the liquid a fine powder comprising sugar having a particle size less than 45 microns, wherein the fine powder is incorporated as at least 20% by weight of the confectionery product;
agitating the liquid and fine powder at a temperature above the melting temperature of the cocoa butter to form a cohesive dough; and thereafter
solidifying the dough to form the confectionery product having a fat content in the range of 28% to 33% by weight.

17. The method of claim 16, wherein the sugar in the fine powder is at least 50% by weight of the total amount of sugar in the formed confectionery product.

18. The method of claim 16, wherein the powder is incorporated as at least 35% by weight of the formed confectionery product.

19. The method of claim 16, wherein the fine powder further comprises cocoa powder.

20. A confectionery product manufactured according to the method of claim 1.
